(19) United States
(12) Patent Application Publication
(10) Pub. No.: US 2010/0043378 A1
(43) Pub. Date: Feb. 25, 2010

(54) CUTTING BLADE ASSEMBLY FOR A MOWER

(76) Inventor: Raymond Eric Abernethy, Toowong (AU)

Correspondence Address: STEFAN KIRCHANSKI, VENABLE LLP 2049 CENTURY PARK EAST, 21ST FLOOR, LOS ANGELES, CA, 90067, US

(21) Appl. No.: 11/916,443

(22) PCT Filed: May 2, 2006
(86) PCT No.: PCT/AU06/00571

§ 371 Date: May 1, 2008

(30) Foreign Application Priority Data
Apr. 29, 2005 (AU) 2005902157

(51) Int. Cl. A01D 34/00; A01D 34/73; B23P 11/00

(52) U.S. Cl. 56/295; 56/17.5; 56/10.1; 29/428

(57) ABSTRACT

A cutting blade assembly (8) for a rotary mower. The assembly (8) comprises a blade carrier (1) and four swing-back cutting blades (10) (only one of which is shown). The blade carrier (1) has a substantially planar discoid body (2), a mount (3) for mounting the body (2) to a drive shaft assembly (not shown) of the mower, four airflow passages (5) extending through the body (2), and a blade connecting mechanism (6) for connecting the blades (10) to the body (2). The body (2) is made of laser- or plasma-cut, high-strength steel (Bisplate 80™) having a thickness in the order of 5 to 6 mm.

### TECHNICAL FIELD

This invention relates to blade carriers, cutting blades and cutting blade assemblies for rotary mowers.

### BACKGROUND ART

Rotary mowers typically have a deck and two or more cutting blades rotatable within the deck. The blades usually extend from opposing sides of a blade carrier of the mower. A drive shaft assembly, which is either directly or indirectly coupled to a motor of the mower, is connected to the blade carrier. Some mowers, such as ride-on mowers, have two or more decks and/or drive shafts.

For some types of mowers the cutting blades and blade carrier are of unitary construction. This is the case with bar-type cutters which have blades at opposing ends of a bar-shaped blade carrier. Disadvantages with bar-type cutters include that: cutting blades cannot be replaced independently of the carriers; they have to be balanced after sharpening one or more of the blades; and, damage can be caused to the drive shaft assembly, motor or deck when striking a foreign object during mowing.

For some types of mowers the blade carrier is cone shaped and two or more cutting blades extend from the cone. Disadvantages with such a carrier include that: it may be time consuming and expensive to manufacture; it may not be manufacturable in a single operation; it can only be used with certain deck types; and, the one size carrier and the one size blades connected thereto may not be able to be used in decks of different sizes.

It is an object of the present invention to provide a blade carrier, cutting blade or cutting blade assembly which minimises or ameliorates one or more of the disadvantages referred to above, or to provide the public with a useful or commercial choice.

### DISCLOSURE OF INVENTION

According to a first aspect of the present invention, there is provided a blade carrier for a mower, said carrier comprising:

a substantially planar discoid body;

a mount for mounting the body to a drive shaft assembly of the mower;

at least one passage in the body enabling airflow from above the body to below the body; and

a cutting blade connecting mechanism for connecting at least one cutting blade to the body.

The body can be of any suitable size, shape and construction. Preferably, the body is circular, planar and has a thickness in the order of about 3-10 mm, and more preferably about 5-6 mm.

Any suitable type of mount can be used. The mount can comprise the body having a central aperture (at the axis of rotation of the body) that is engageable by a shaft of the drive shaft assembly and a locking bolt can fasten the body and shaft together. Preferably, the shaft is splined, the shape of the central aperture matches the shape of the shaft and a locking bolt extends from below the body into the shaft.

Alternatively, the mount can comprise the body having a central aperture and apertures extending radially from the central aperture. Each radially extending aperture can be a slot. A respective bolt for further fastening the drive shaft assembly to the body can extend through any radially extending aperture.

Alternatively, the mount can comprise an adapter for mounting the drive shaft assembly to the body. The adapter can be connected to the body with bolts that extend through the apertures. A shaft of the drive shaft assembly can be bolted to the adapter.

Any suitable type of blade connecting mechanism can be used. The connecting mechanism can comprise the body having an opening, a fastening bolt can be extended through the body opening and further through an opening in the blade, and a nut can secure the body and blade together. Preferably, the blade connecting mechanism comprises radially extending series of openings in the body such that one or more blades can be connected to the body at different distances from the central aperture/the axis of rotation of the body. In this way, the carrier can be used to carry blades of the same or differing lengths and the one size carrier can then be used in mower decks of differing diameter.

The carrier can have any suitable number of airflow passages. The passages can be of any suitable shape and size. Preferably, the carrier has two, three or four passages and the passages are situated such that the carrier is rotationally balanced. Preferably, each passage corresponds to a cut out portion of the body. Preferably, each airflow passage is located between the central aperture/the axis of rotation and a periphery of the body, and between blades that are adjacent to one another.

The body can be made of any suitable material or materials. Preferably, the body is made of laser- or plasma-cut, high-strength steel. The body is preferably made of Bisplate 80™ which is manufactured in Australia by Bisalloy Steels Pty Ltd.

According to a second aspect of the present invention, there is provided a cutting blade assembly comprising a blade carrier having a substantially planar discoid body and at least one cutting blade extending from the body.

The carrier can have one or more features as described in respect of the first aspect of the invention.

The blade can be of any suitable size, shape and construction. The blade can be made of any suitable material or materials, such as high-strength steel. The carrier and blade can be of unitary construction or the blade can be detachably connected to the carrier.

Preferably, the assembly has 2, 3, 4 or 6 cutting blades extending radially from the carrier.

The blade can have at least one baffle for producing upward air movement and/or at least one baffle for producing downward air movement. The baffles can be provided by upturned and downturned (twisted) regions of the blade. A distal end of the blade relative to the carrier can be upturned and a proximal end of the blade relative to the carrier can be downturned. Preferably, a distal trailing end of the blade is upturned and a proximal trailing end of the blade is downturned such that airflow through the passage and recirculation to an upper region of the deck is encouraged.

The choice of blade will depend, inter alia, on whether lawn clippings are to be circulated within a non-ventilated, minimally ventilated or discharge restricted deck of the mower and dispersed onto the lawn (“mulching mode”), or whether the deck is to be well ventilated such that air is induced to flow into the deck or discharge is not restricted so that lawn clippings can be really discharged from the deck into a collector (“discharge mode”). A blade having only a downturned region or both upturned and downturned regions is preferred for the mulching mode. A blade having only an upturned region or both upturned and down turned regions is preferred for the discharge mode.

Preferably, the blade is a swing back blade that can pivot about its attachment point relative to the body. That is, when the blade strikes an object, the blade swings from the normal extended position to a retracted position until the centrifugal force can again move the blade back to the normal extended position.

Alternatively, the blade can be a type of swing back blade that is retained in the normal extended position by way of a detent and only swings back when impacted upon by a sufficiently large force. That is, when the blade strikes a large-sized object, the detent yields and the blade is able to swing from the normal extended position to the retracted position. The detent can be of any suitable size, shape and construction. For instance, a washer positively locked to the body can have a projection that extends alongside the blade and the projection can bend or break when the blade strikes a sufficiently large object.

The blades can extend from the body so as to provide a single cutting plane. Alternatively, the blades can extend from the body so as to provide two or more cutting planes. The blades can also extend to provide differing radial cutting diameters.

According to a third aspect of the present invention, there is provided a cutting blade for a blade carrier comprising a substantially planar discoid body, said cutting blade having one or more features as described in respect of the second aspect of the invention.

According to a fourth aspect of the present invention, there is provided a mower comprising at least one blade carrier according to the first aspect of the invention, at least one cutting blade assembly according to the second aspect of the invention, or at least one cutting blade according to the third aspect of the invention.

The mower can be any suitable type of lawnmower, but is preferably a ride-on mower having one, two or three drive shafts, that otherwise may utilise straight bar carriers. A suitable ride-on mower is Model Number YTH1542XP, manufactured by Husqvarna™.

According to a fifth aspect of the present invention, there is provided a method for manufacturing a blade carrier for a rotary mower, said method comprising the steps of:

cutting a sheet of material so as to provide a substantially planar discoid body;

forming an opening in the body so as to provide a mount for mounting the body to a drive shaft assembly of the mower;

forming at least one passage in the body enabling airflow from above the body to below the body; and

forming an opening in the body so as to provide a cutting blade connecting mechanism for connecting at least one cutting blade to the body.

Preferably, the sheet of material is high-strength steel and the carrier is made by laser cutting or plasma cutting the steel. The body is preferably made of Bisplate 80™.

The blade carrier according to the fifth aspect of the invention can have one or more features as described in respect of the first aspect of the invention.

Preferred embodiments of the invention will now be described by way of example with reference to the accompanying drawings.

### BRIEF DESCRIPTION OF THE DRAWINGS

FIG. 1 is a detailed plan view of a cutting blade assembly comprising a blade carrier and a cutting blade, according to an embodiment of the invention;

FIG. 2 is a detailed plan view of a cutting blade assembly comprising a blade carrier and a cutting blade, according to an embodiment of the invention;

FIG. 3 is a detailed plan view of a cutting blade assembly comprising a blade carrier and a cutting blade, according to an embodiment of the invention;

FIG. 4 is a plan view of a blade carrier according to an embodiment of the invention;

FIG. 5 is a detailed side elevation view of part of a cutting blade assembly comprising a blade carrier and a cutting blade, according to an embodiment of the invention;

FIG. 6 is a detailed side elevation view of the cutting blade assembly shown in FIG. 1;

FIG. 7 is a detailed side elevation view of the cutting blade assembly shown in FIG. 2;

FIG. 8 is a detailed side elevation view of the cutting blade assembly shown in FIG. 3;

FIG. 9 is a detailed side elevation view of the cutting blade assembly shown in FIG. 1 and further showing airflow direction;

FIG. 10 is a detailed side elevation view of the cutting blade assembly shown in FIG. 2 and further showing airflow direction;

FIG. 11 is a detailed side elevation view of the cutting blade assembly shown in FIG. 3 and further showing airflow direction;

FIG. 12 is a detailed side elevation view of part of a cutting blade assembly comprising a blade carrier and a cutting blade, according to an embodiment of the invention;

FIG. 13 is a detailed exploded view of part of the cutting blade assembly shown in FIG. 12;

FIG. 14 is a detailed side elevation view of part of a cutting blade assembly being used to cut lawn, according to an embodiment of the invention;

FIG. 15 is a perspective view corresponding to FIG. 14; and

FIG. 16 is an exploded view of part of a cutting blade assembly, according to an embodiment of the invention.

### DESCRIPTION OF THE PREFERRED EMBODIMENTS

In the figures, like reference numerals refer to like features.

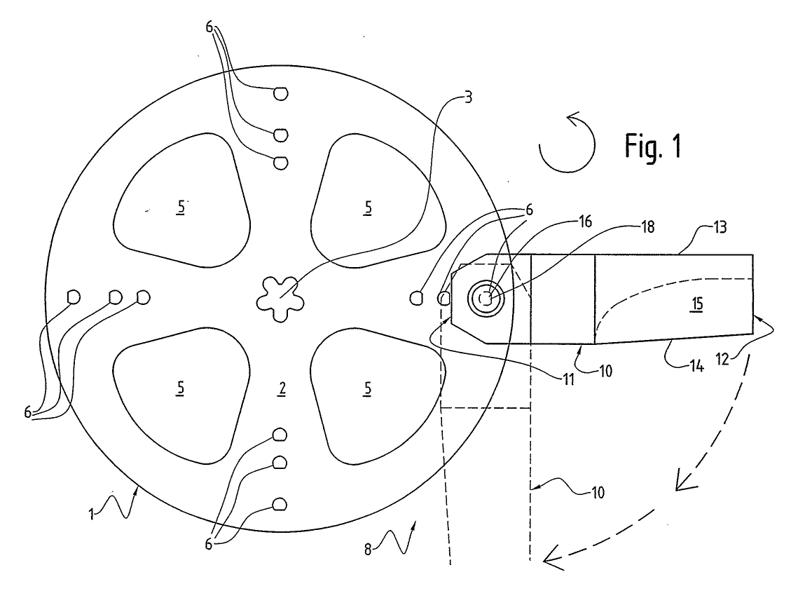

FIGS. 1 and 6 show a cutting blade assembly 8 for a rotational mower. The assembly 8 comprises a blade carrier 1 and four cutting blades 10 (only one of which is shown). The blade carrier 1 has a substantially planar discoid body 2, a mount 3 for mounting the body 2 to a drive shaft assembly (not shown) of the mower, four airflow passages 5 extending through the body 2, and a connecting mechanism 6 for connecting the blades 10 to the body 2.

The body 2 is made of laser-cut, high-strength steel (Bisplate 80™) having a thickness in the order of 5 to 6 mm.

The drive shaft connecting mechanism 3 comprises a star-shaped central aperture 3. A splined shaft of the drive shaft assembly is engageable with the central aperture 3. A bolt is extendable through the central aperture 3 and within a threaded interior of the shaft to hold the shaft and body 2 together.

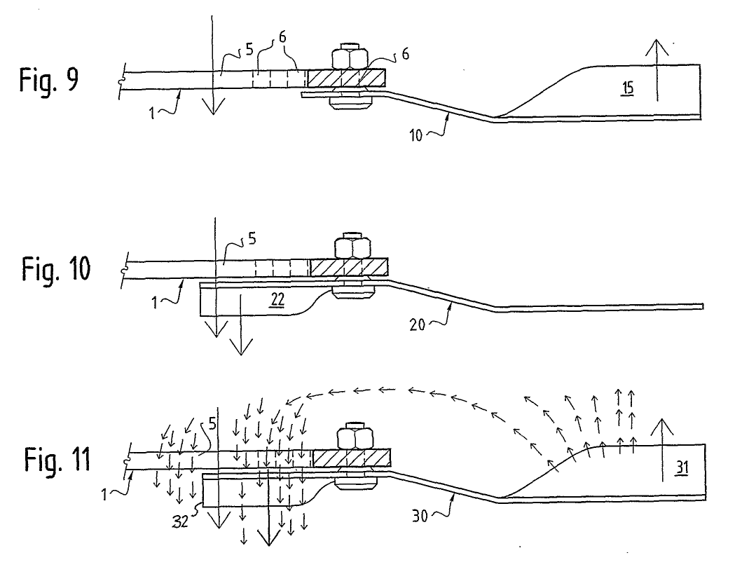

The blade 10 is made of high-strength steel. The blade 10 has a proximal end 11 and a distal end 12. The blade 10 also has a leading cutting end 13 and a trailing end 14 with regard to the direction of rotation of the body 2 (shown in FIG. 1). The distal end 12 of the blade 10 has an upturned region 15 (a baffle) for producing upward air movement. Airflow direction is illustrated by way of arrows in FIG. 9.

The blade connecting mechanism 6 comprises series of radially extending D-shaped openings 6 in the body 2. A fastening bolt 18 (see FIG. 6) having a D-shaped shank (as seen in FIG. 1) is extendable through any one of the openings 6 and through a circular opening 16 in the blade 10. A nut 19 may be screwed onto the bolt 18 to hold the blade 10 and body 2 together. The blade 10 pivots about a shoulder (not shown) of the bolt 18, the shoulder being adjacent a head of the bolt 18. A washer 25 is located between the shoulder and the body 2. The blade 10 is a swing back blade that can pivot about the shoulder relative to the body 2. That is, when the blade 10 strikes a foreign object, the blade 10 swings from the normal extended position (shown in solid lines in FIG. 1) to a retracted position (shown in broken lines in FIG. 1) until the centrifugal force can again move the blade 10 back to the normal extended position.

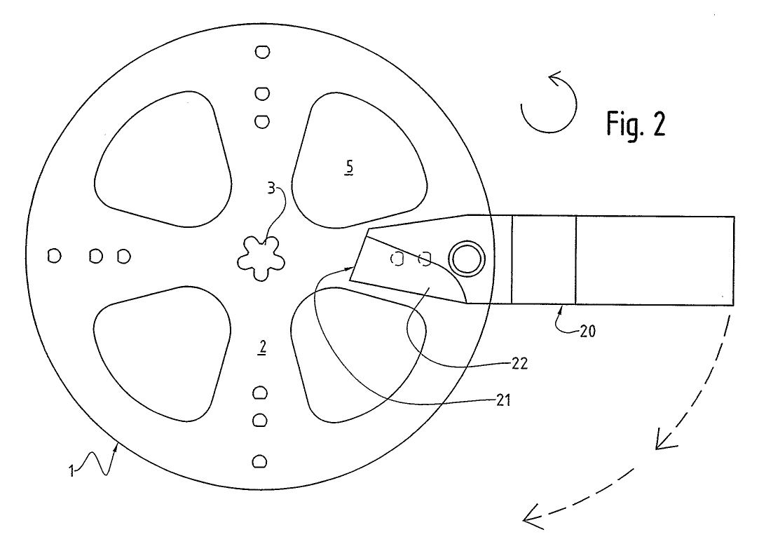

FIGS. 2 and 7 show the blade carrier 1 of FIG. 1 but attached to a different type of swing back blade 20, according to another embodiment of the invention. Instead of having an upturned region for producing upward air movement, a proximal end 21 of the blade 20 has a downturned region 22 (a baffle) for producing downward air movement. Airflow direction is illustrated by way of arrows in FIG. 10.

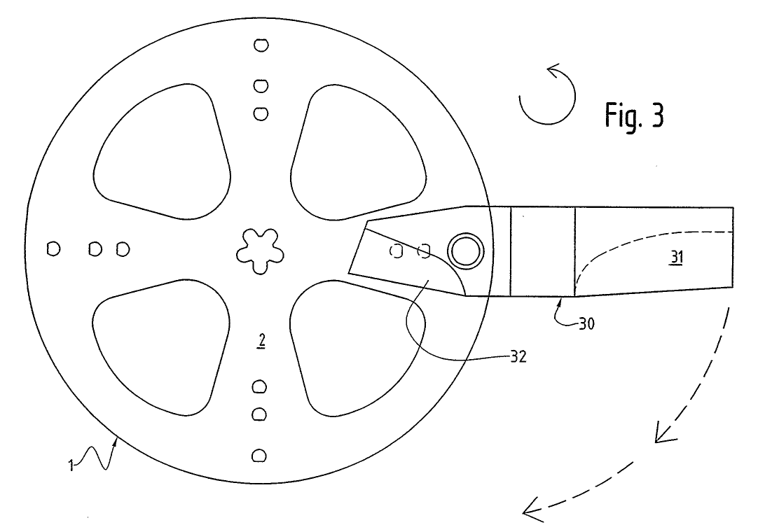

FIGS. 3 and 8 show the blade carrier 1 of FIG. 1 but attached to a different type of swing back blade 30, according to another embodiment of the invention. The blade 30 has an upturned region 31 for producing upward air movement and a downturned region 32 for producing downward air movement. Airflow direction is illustrated by way of arrows in FIG. 11.

FIG. 4 shows a blade carrier 40 according to another embodiment of the invention. The blade carrier 40 has a body 41 and a cutting blade connecting mechanism 42 (labelled in part) as described for blade carrier 1 of FIG. 1. The blade carrier 40 differs from blade carrier 1, however, with regard to the shape of the airflow passages 43 and mount 44, 45 for the drive shaft assembly.

The mount 44, 45 includes a central aperture 44 and four slots 45 that extend radially from the central aperture 44. The central aperture 44 and slots 45 can each receive a fastening bolt. A bolt is extendable through the central aperture 44 and within a threaded shaft of the drive shaft assembly to bolt the shaft and body 2 together. A respective bolt is also extendable through each slot 45 into another component of the drive shaft assembly and/or a drive shaft assembly adapter (not shown). The mount 44, 45 may be referred to as a “universal mount”.

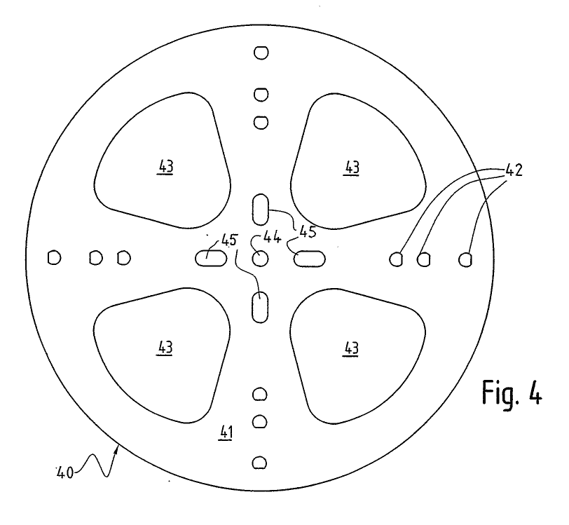

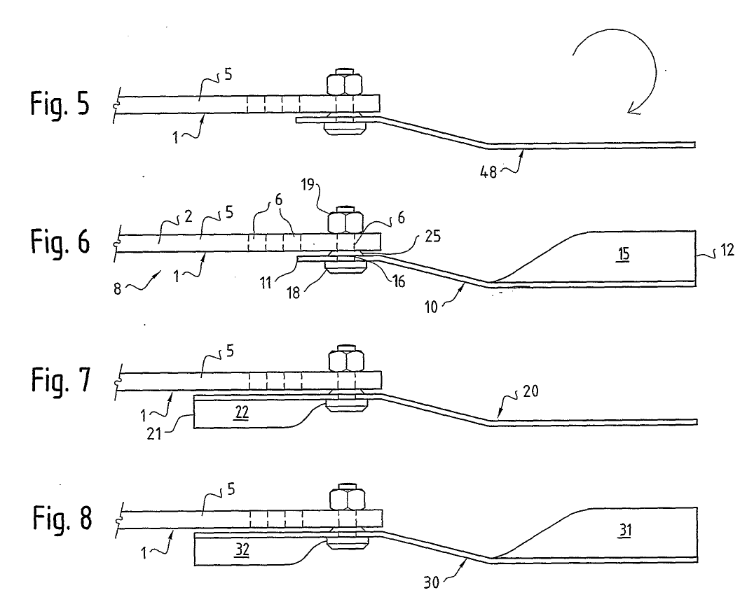

FIG. 5 shows the blade carrier 1 of FIG. 1 connected to yet another type of cutting blade 48. Blade 48 has neither an upturned region nor a downturned region.

The choice of blade 10, 20, 30, 48 type will depend on whether the mower is to be used for general mowing, in a mulching mode, or in a discharge mode. Blade 20 and blade 30, in particular, would be normally used in the mulching mode. FIG. 11 illustrates how the upturned 31 and downturned 32 regions of blade 30 enhance air circulation in a non-ventilated deck (or an air-induced (ventilated) deck with a restricted discharge outlet) by way of the passages 5. Blade 10 and blade 30 would be normally used in the discharge mode. Blade 48 would normally be used for general mowing purposes, or in concert with blade 10 when requiring less assisted discharge.

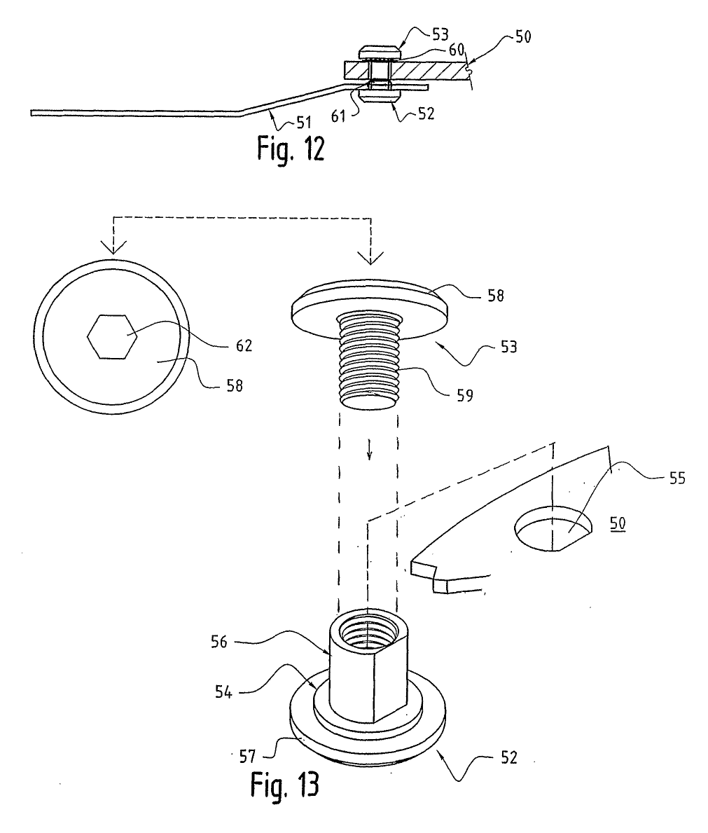

FIGS. 12 and 13 depict a low profile nut 52 and bolt 53 for connecting a swing back blade 51 to a blade carrier body 50, according to another embodiment of the invention. The nut 52 has a shank 56, a flange 57 and a shoulder 54 intermediate the shank 56 and the flange 57. A thread extends through the shank 56, shoulder 54 and flange 57. The shank 56 is extendable through a D-shaped opening 55 in the body 50 and a circular opening in the blade 51. The shank 56 has an anti-turn flat face (or fillet). The bolt 53 has a head 58 with an alien key drive 62 and a threaded shaft 59 that is extendable within the shank 56. A spring steel anti-vibration lock washer 60 is located between the head 58 and the body 50. A spring washer 61 is located between the body 50 and the shoulder 54. The blade 50 pivots about the shoulder 54.

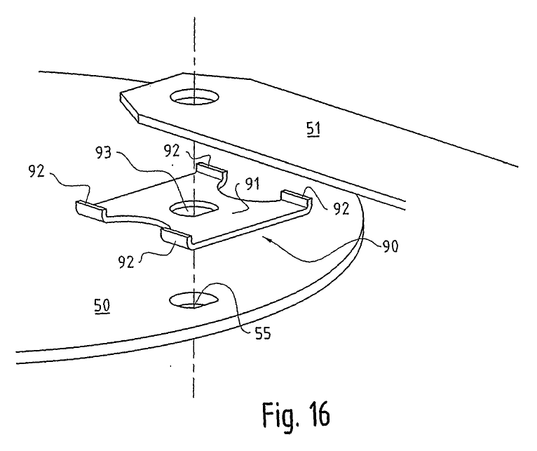

Alternatively, as shown in FIG. 16, the swing back blade 51 can be retained in the normal extended position by way of a detent 90 and the blade 51 only swings back when impacted upon by a sufficiently large force. The detent 90 has a planar body 91 and projections 92 that extend perpendicularly from the plane of the body 91. The projections 92 extend along opposing sides of the blade 51. A D-shaped opening 93 in the body 91 enables the detent 90 to be positively locked to the carrier body 50 by way of the fillet of the shank 56. The detent 90 can be used in place of the spring washer 61 between the head 58 and the body 50. When the blade 51 strikes a large-sized object, some of the projections 92 of the detent 90 yield and the blade 51 is able to swing from the normal extended position to the retracted position.

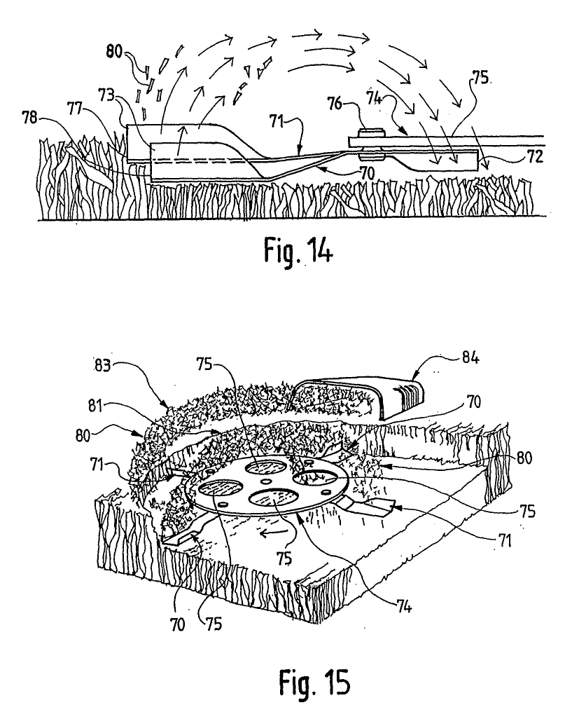

FIGS. 14 and 15 depict cutting blades 70, 71 like blade 30 shown in FIG. 11. Each blade 70, 71 has an upturned region 73 and a downturned region 72. However, the blades 70, 71 extend from a blade carrier 74 so as to provide two cutting planes 77, 78 in two radial cutting diameters. The blade connecting mechanism 76 is like the one illustrated in FIGS. 12 and 13.

FIG. 14 depicts a mower in the mulching mode (ie. having a non-ventilated mower deck or a ventilated deck with a restricted discharge outlet), wherein lawn clippings 80 are circulated through an upper part of the deck (not shown) and through passages 75 of the blade carrier 74 onto the cut lawn. The upturned region 73 lifts the lawn for cutting and directs the clippings 80 towards the upper part of the deck. The downturned region 72 draws the clippings 80 through the passages 75 onto the cut lawn. FIG. 15 also depicts the pathway 81 followed by the clippings 80 when the mower is in the mulching mode.

FIG. 15 further depicts the pathway 83 followed by clippings 80 when the mower is in the discharge mode, wherein the clippings 80 are directed to a collector (not shown) or to an adjacent lawn surface by way of a discharge chute 84.

Advantages of the blade carrier and cutting blades of the preferred embodiments of the present invention over conventional bar-type cutters include that:
Individually worn or damaged cutting blades can be more readily accessed and economically replaced;
The blade assembly is less balance sensitive to differential blade wear;
There is no need to balance the blade carrier together with the blades;
The discoid shape of the blade carrier is less likely to cause damage to the drive shaft assembly, motor and deck when striking a foreign object during mowing;
Swing back blades would further lessen the likelihood of the drive shaft assembly, motor and deck being damaged when striking a foreign object during mowing;
Swing back blades would lessen the likelihood of dangerous objects being flung out from under the deck;
A carrier having four blades has double the cutting action per revolution;
Having double the cutting action ensures the operator may increase the rate of progress whilst maintaining the quality of the cutting action, thus reducing the overall mowing time;
A more even cut lawn results due to the shape of the carrier and its inherent momentum;
Although a blade may be damaged in a 4-blade assembly, the mowing task may nevertheless be completed upon removing the opposing blade; and
The beneficial “gyroscopic” effect of the carrier and blades dampens unwanted “pulse” action by offsetting the effect of rapidly varying grass densities, thereby enhancing the safety and longevity of the motor and transmission components, whilst maintaining the consistency of the cut.

Furthermore, the operator has the choice of connecting different types of blades to the carrier, to bias the performance of the mower. Straight blades can be connected for general mowing purposes. Upturned blades can be connected for discharge mowing. Downturned blades can be connected for mulching. Upturned and downturned blades can be connected to enhance air induction or vortex generation in the mulching mode and/or discharge mode. Blades which produce two cutting planes and two cutting diameters can be connected so as to increase mulching capacity and enhance the quality of the cut. Advantages of the blade carrier of the present invention include that:
It can be readily and cost effectively manufactured;
It allows safer and more cost effective use of swing back blades;
The carrier, once installed, would not normally be subject to replacement as it becomes part of the drive component supporting the replaceable blades;
It can be manufactured in a single operation, without any further shaping or treatment;
The laser-cutting technique provides impeccable dimension tolerance and uniformity;
No special machine dies, tooling, presses or the like are required to be pre-manufactured and/or duplicated if simultaneously manufacturing the carrier in different locations;
Manufacturing can commence in any location on the basis of drawings alone;
Design changes may be incorporated at any time or anywhere on the simple basis of emailing the changed design drawings;
Manufacturing can be halted and recommenced immediately with incorporated abovementioned changes without the need for tooling changes and attendant downtime;
The ability to have one size carrier (and the one size blades connected thereto) service different size decks (by way of the multiple blade attachment points); and
Since it is substantially planar, it does not hinder airflow through the deck, as would a cone-shaped carrier.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

1. A blade carrier for a mower, said carrier comprising:
a substantially planar discoid body;
a mount for mounting the body to a drive shaft assembly of the mower;
at least one passage in the body enabling airflow from above the body to below the body; and
a cutting blade connecting mechanism for connecting at least one cutting blade to the body.

2. The blade carrier of claim 1, wherein the body is circular, planar and has a thickness of about 3-10 mm.

3. The blade carrier of claim 1, wherein the mount comprises the body having a central aperture that is engageable by a shaft of the drive shaft assembly and a locking bolt which fastens the body and shaft together.

4. The blade carrier of claim 3, wherein the shaft is splined, the shape of the central aperture matches the shape of the shaft and the locking bolt extends from below the body into the shaft.

5. The blade carrier of claim 1, wherein the blade connecting mechanism comprises the body having an opening, a fastening bolt extending through the body opening and further through an opening in the blade, and a nut securing the body and blade together.

6. The blade carrier of claim 5, wherein the connecting mechanism comprises radially extending series of openings in the body such that the blade is connectable to the body at different distances from an axis of rotation of the body.

7. The blade carrier of claim 1, wherein the passage corresponds to a cut out portion of the body.

8. The blade carrier of claim 1, wherein the carrier has two, three or four passages and the passages are situated such that the carrier is rotationally balanced.

9. The blade carrier of claim 1, wherein the body is made of laser- or plasma-cut, high-strength steel.

10. A cutting blade assembly comprising the blade carrier as defined in claim 1 and at least one cutting blade extending from the body.

11. The cutting blade assembly of claim 10, wherein the blade has at least one a baffle for producing upward air movement and/or at least one baffle for producing downward air movement.

12. The cutting blade assembly of claim 10, wherein the blade is a swing back blade that pivots about its attachment point relative to the body.

13. The cutting blade assembly of claim 10, wherein the assembly comprises a plurality of cutting blades and the blades extend from the body so as to provide a single cutting plane.

14. The cutting blade assembly of claim 10, wherein the assembly comprises a plurality of cutting blades and the blades extend from the body so as to provide two or more cutting planes.

15. A mower comprising at least one blade carrier as defined in claim 1.

16. The mower of claim 15, wherein the mower is a ride-on mower having one, two or three drive shafts.

17. A method for manufacturing a blade carrier for a rotary mower, said method comprising the steps of:
cutting a sheet of material so as to provide a substantially planar discoid body;
forming an opening in the body so as to provide a mount for mounting the body to a drive shaft assembly of the mower;
forming at least one passage in the body enabling airflow from above the body to below the body; and
forming an opening in the body so as to provide a cutting blade connecting mechanism for connecting at least one cutting blade to the body.

18. The method of claim 17, wherein the sheet of material is high-strength steel and the carrier is made by laser cutting or plasma cutting the steel.

19. A cutting blade when used for the blade carrier as defined in claim 1.
